(19) United States
(12) Patent Application Publication
(10) Pub. No.: US 2022/0388654 A1
(43) Pub. Date: Dec. 8, 2022

(54) DRONE AIRCRAFT WITH MAGNETIC CONSTRUCT

(71) Applicant: Dushan Kandasamy, London (GB)

(72) Inventor: Dushan Kandasamy, London (GB)

(21) Appl. No.: 17/761,689

(22) PCT Filed: Sep. 18, 2020
(86) PCT No.: PCT/IB2020/058711

§ 371 Date: Mar. 25, 2021

(30) Foreign Application Priority Data
Sep. 18, 2019 (GB) 1913480.8

(51) Int. Cl. B64C 39/02; B64C 25/62

(52) U.S. Cl. CPC B64C 39/024; B64C 25/62; B64C 2201/027; B64C 2201/145; B64C 2201/127; B64C 2201/162; B64C 2201/06

(57) ABSTRACT

The present invention discloses a drone, comprising a cyclical hull with one or more cyclical rings, an external structure, and a piezoelectric system. The external structure comprises a fixed wing and a rotary turbine construction. The external structure is securely and rotationally connected to the cyclic ring. The external structure is configured to rotate exponentially around the cyclical hull, thereby enabling a stabilization capability of the drone to forward in the desired direction. The piezoelectric system is mounted on the cyclical hull for efficiently analyzing onward wind direction, thereby effectively rotating the external structure at high speeds to enable the structural integrity of the drone. The drone further comprises one or more locking systems to unlock the cyclical rotational turbine based on an alert received from the piezoelectric system. Further, the drone comprises a camera for capturing a surrounding view of the drone.

### CROSS-REFERENCE TO RELATED APPLICATIONS

This application claims priority to PCT International Patent Application No. PCT/IB2020/058711, titled “Drone Aircraft With Magnetic Construct” filed on Sep. 18, 2020; which further claims priority to UK Patent Application No. GB 1913480.8, titled “Drone Aircraft With Magnetic Construct” filed on Sep. 18, 2019. The specification of the above referenced patent applications are incorporated herein by reference in its entirety.

### BACKGROUND OF THE INVENTION

### A. Technical Field

The present invention generally relates to a drone aircraft. More specifically, the present invention relates to a drone aircraft embedded with various structures and rotates instantaneously in any direction for effective harvesting of onward wind force.

### B. Description of Related Art

There are several developments have been made in the field of vehicles. In recent years, several technological advancements have been made in the flying drone, also called as an unmanned aerial vehicle (UAV). In general, the flying drones comprises a main body and several directional means. The direction means comprises a motor with a propeller arrangement. Further, the conventional flying drones comprise power sources and positioning systems.

There is a multitude of permutations and combinations of this particular technology. The use of a remotely operable drone is becoming more widespread as their technical capability is increasing in different aspects such as increased flight time and carrying cameras. These kinds of drones are used in various fields such as in military, police, news agencies, other commercial businesses, and private individuals. Such components could fragile in view of protentional risks such as unexpected weather conditions and unforeseen wind force.

A prior art, US20060049304A1 of John Sanders et al., discloses a hover aircraft employs an air impeller engine having an air channel duct and a rotor with outer ends of its blades fixed to an annular impeller disk that is driven by magnetic induction elements arrayed in the air channel duct. The air-impeller engine is arranged vertically in the aircraft frame to provide vertical thrust for vertical takeoff and landing. Preferably, the air-impeller engine employs dual, coaxial, contra-rotating rotors for increased thrust and gyroscopic stability. Another prior art, US20050082421A1 of Pietro Perlo et al., discloses a flying machine includes a supporting structure including a central rotational support having a vertical axis connected to an essentially horizontal, preferably annular, peripheral support part, coaxial with the central support, at least one upper rotor including a central hub rotatable about the axis of the central support of the supporting structure, an outer channel-section ring supported by the peripheral part of the supporting structure by contactless suspension means, preferably magnetic suspension means, and a plurality of blades which extend from the hub to the channel-section ring and which are inclined with respect to the horizontal plane; and motor devices carried at least partially by the peripheral part of the supporting structure and operable to cause rotation of the rotor with respect to this structure in a predetermined direction.

Another prior art, U.S. Pat. No. 10,101,443B1 of Louis Leroi et al., discloses an aerial vehicles may be outfitted with one or more ultrasonic anemometers, each having ultrasonic transducers embedded into external surfaces. The transducers may be aligned and configured to transmit acoustic signals to one another, and receive acoustic signals from one another, along one or more paths or axes. Yet another prior art, US20180370624A1 of Joseph B. Seale et al., discloses an aircraft's two wings and joined thruster propellers or turbines serve as rotary wings in helicopter mode and as fixed wings in airplane mode. Yet another prior art, U.S. Pat. No. 10,160,541B1 of Brian C. Beckman et al., discloses an unmanned aerial vehicle that includes a lifting propulsion mechanism that is circumferentially-driven and includes a propeller assembly and a propeller rim enclosure. The propeller assembly includes a plurality of propeller blades that extend radially and are coupled to an inner side of a substantially circular propeller rim that encompasses the propeller blades. However, above-mentioned prior arts fails to disclose a drone aircraft with a magnetic locking system or a Bluetooth locking mechanism, configured to lock and unlock the energy harvesting mechanism and turbine assembly by receiving alerts and/or signals from the plurality of sensors of the piezoelectric system.

In light of the above-mentioned drawbacks, there is also a need for an improved drone construction to enable an angular momentum and a gyroscopic balancing effect at high-speed rotation. Further, there is a need for a drone aircraft to rotate instantaneously in any direction for the effective harvesting of onward wind force.

### SUMMARY OF THE INVENTION

The present invention generally discloses a drone or a drone aircraft. Further, the present invention discloses a drone aircraft having a rotatable assembly to fully capitalize and optimize the drone aircraft on wind direction. Further, the drone aircraft could be embedded with various structures and rotates instantaneously in any direction for effective harvesting of onward wind direction

According to the present invention, the drone is configured to efficiently harvest the wind energy. In one embodiment, the drone could be a drone aircraft. In one embodiment, the drone could be an autonomous drone. In one embodiment, the drone comprises a cyclical hull. In one embodiment, the cyclical hull comprises a shape includes, but not limited to, a circular shape or a round shape. In one embodiment, the drone further comprises one or more external structure. In one embodiment, the external structure comprises a fixed wing and a rotary turbine assembly. In one embodiment, the external structure is securely and rotationally connected to a rotational mechanism via a rotating rod, thereby enabling the external structure to rotate in both clockwise direction and anti-clockwise direction to enable easy maneuver of the drone to rotate in both clockwise direction and anti-clockwise direction to enable easy maneuver of the drone.

In one embodiment, the drone comprises one or more energy harvesting mechanisms and a piezoelectric system. In one embodiment, the piezoelectric system is mounted on the outer cyclical hull for efficiently analyzing the onward wind direction, thereby effectively rotating the external structure at high speeds. The high-speed rotation of external structure in the outer cyclical ring enables the structural integrity of the drone. In one embodiment, the rotation of the external structure enables an angular momentum mechanism and a gyroscopic balancing effect of the drone. In one embodiment, the external structure is held in a place using an opposing magnetic field or an opposing magnet-based construction.

In one embodiment, the angular momentum mechanism is imbued with opposing magnetic-based constructions, wherein the opposing magnetic-based constructions function to levitate and effectively float the angular momentum mechanism, which subsequently enables the slightest indentation of force to induce the rotation of an outer ring of the drone. In one embodiment, the opposing magnetic-based constructions are configured to enable the drone to effectively float until the respective direction is determined and subsequently locked in place upon forwarding movement. In one embodiment, the opposing magnetic-based constructions act as a levitating mechanism to reduce the degrees of friction, wear and tear of the motorized gear constructions. In one embodiment, the opposing magnetic-based constructions include one or more magnetic levitation rings.

In one embodiment, the drone further comprises one or more locking system. In one embodiment, the locking systems are utilized to unlock the cyclical rotational turbine assembly based on an alert or message received from the piezoelectric system. The locking system could perform various locking operations based on the capacity of the drone to absorb the shock of oncoming unexpected weather conditions. In one embodiment, the cyclical rotational turbine assembly absorbs a large portion of an excessive flight destabilizing wind and a respective harvested energy, thereby enabling the gyroscopic balancing of the drone by reducing the oncoming wind force. In one embodiment, the turbine assembly is a vertical axis motorized turbine assembly. In one embodiment, the turbine assembly is a cylindrical wind turbine assembly.

In one embodiment, the drone could be constructed with various redundancy copter mechanisms. In one embodiment, the redundancy copter mechanisms could extract outwards extend and rotate upon one or more coaxial motors in the center of the respective drone. In one embodiment, the drone further comprises an electronic system and one or more suspension spring-based landing mechanisms. The landing mechanisms are integrated into the bottom side of the drone. In one embodiment, the landing mechanisms could extend downwards during landing to facilitate a more proficient landing process. In one embodiment, the drone further comprises one or more cameras mounted to the outer mechanism of the drone. The camera could rotate around the cyclical hull using a motorized construction, for capturing a surrounding view of the drone.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a top view of a drone or a drone aircraft in one embodiment of the present invention.

FIG. 2 shows the drone constructed with various redundancy copter mechanisms in one embodiment of the present invention.

FIG. 3 shows the drone having a vertical turbine assembly in one embodiment of the present invention.

FIG. 4 shows a perspective of the drone in one embodiment of the present invention.

FIG. 5 shows a perspective view of contra rotating blades or propellers or fixed wings of the drone at one position in one embodiment of the present invention.

FIG. 6 shows a perspective view of contra rotating blades or propellers or fixed wings of the drone at another position in one embodiment of the present invention.

FIG. 7 shows a perspective view of contra rotating blades or propellers or fixed wings of the drone at yet another position in one embodiment of the present invention.

FIG. 8 shows a perspective view of a power storage unit of the drone in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

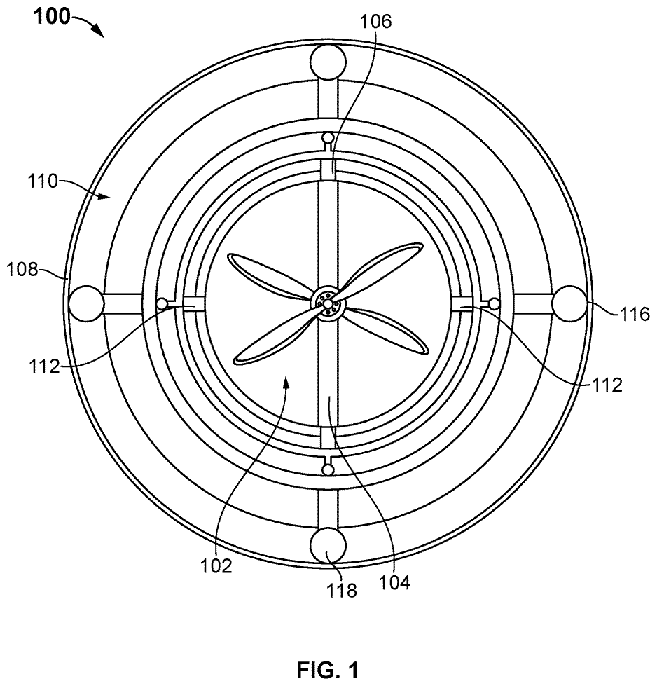

Referring to FIG. 1, a top view of a drone or a motorized drone 100 is disclosed, wherein the drone 100 is configured to efficiently harvest the wind energy. In one embodiment, the drone 100 could be a drone aircraft. In one embodiment, the drone 100 could be an autonomous drone. In one embodiment, the drone 100 comprises an outer cyclical hull 110. In one embodiment, the outer cyclical hull 110 comprises a shape includes, but not limited to, a circular shape or a round shape. In one embodiment, the drone 100 further comprises one or more external structure 102. In one embodiment, the external structure 102 is securely and rotatably connected to a rotational mechanism 118 via a rotatable connecting rod 104, thereby enabling the external structure 102 to rotate in both clockwise direction and anti-clockwise direction to enable easy maneuver of the drone 100.

In one embodiment, the external structure 102 is a motorized external construction, which is held in place and enables a more professional balance effect. The external structure 102 facilitates a rotational movement at high speeds, which enables the external structure 102. In one embodiment, the rotation movement could be in any direction. In one embodiment, the rotational movement is facilitated by any force impact on the external structure 102. The rotational movement could cycle back to the original dimension after the force impact. For example, the external structure 102 could rotate in any direction with the effect of unexpected wind and it cycles back to the original dimension once the wind has passed. The rotating capacity of the external structure 102 is a crucial element, which alters/reduces the effect of the unexpected weather conditions.

In one embodiment, the drone 100 further comprises one or more energy harvesting mechanisms 106, a piezoelectric system 108 and one or more locking systems 112. In one embodiment, the energy harvesting mechanisms 106 are configured to convert the ambient energy such as light, wind, vibration, sound, and heat directly into electrical energy, which could be utilized for the operation of the drone 100. In one embodiment, the piezoelectric system 108 comprises a plurality of sensors to measure the changes in parameters such as acceleration, strain, wind force, and other weather conditions. In one embodiment, the piezoelectric system 108 is a release locking system, comprising a plurality of sensors securely mounted on the outer cyclical hull 110. The locking system 112 could perform various locking operations based on the capacity of the drone to absorb the shock of oncoming unexpected weather conditions. In one embodiment, the locking system 112 is a magnetic locking system.

In one embodiment, the piezoelectric system 108 performs various mechanisms such as an angular momentum mechanism 116 or the rotational mechanism 118, which enables the efficient assessment of oncoming wind. Based on the ascertained wind capability, the external structure 102 starts to rotate in the desired direction. The high-speed rotation of the external structure 102 enables the angular momentum and a gyroscopic balancing effect of the drone 100 to occur the stabilization capability. In one embodiment, the external structure 102 is synchronized with the plurality of electric sensors of the piezoelectric system 108 mounted on the outer cyclical hull 110. The piezoelectric system 108 is also synchronized with the energy harvesting mechanism 106, which is held in a place by a Bluetooth locking mechanism 114. In one embodiment, the energy harvesting mechanism 106 could be an internal energy harvesting rotational mechanism. Once the sensors of the piezoelectric system 108 impressed or appeared to the unexpected or harsh weather conditions, the Bluetooth locking mechanism 114 substantially unlocks the energy harvesting mechanism 106. The unlocked energy harvesting mechanism 106 starts to rotate around the inner or outer axis of the drone 100 to enable proficient harvesting of kinetic wind energy. The energy harvesting mechanism 106 or wind energy harvesting mechanism could act also as a stabilization mechanism by absorbing torrential wind conditions and reducing the effect of flight dislocation and managing the structural integrity of the construct.

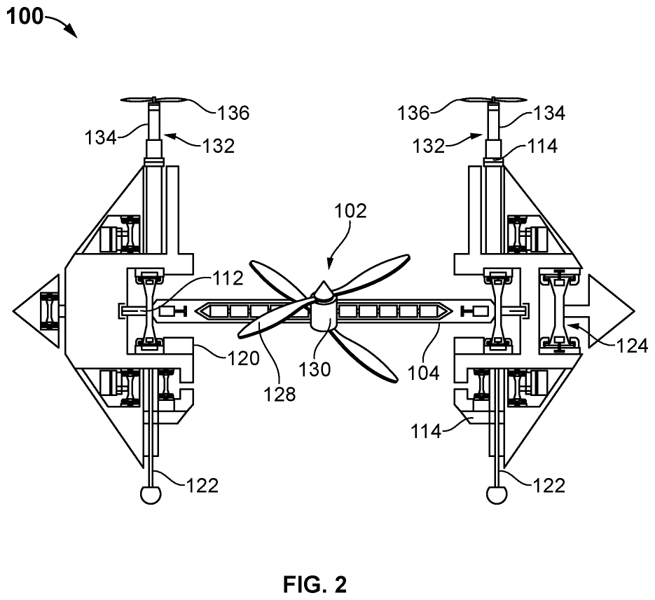

Referring to FIG. 2, the drone 100 constructed with various redundancy copter mechanisms is disclosed. In one embodiment, the angular momentum mechanism 116 is held in an opposing magnetic field or an opposing magnet-based construction 124. In different embodiments, the angular momentum mechanism 116 could be held in place by various opposing magnet-based constructions. The angular momentum mechanism 116 could be imbued with one or more electric charges, which enables the angular momentum mechanism 116 to rotate at extreme speeds around the outer cyclic hull 110 of the drone 100. The opposing magnetic field 124 enables the angular momentum mechanism 116 to effectively float in the opposing magnetic field 124 until determining the respective direction. The angular momentum mechanism 116 is subsequently locked in place during the forward movement of the drone 100. In some embodiments, the opposing magnetic field 124 could hold various structures of the drone in place, which enables the proficiency of frictionless movement and adds to the stabilization of the drone construct.

In one embodiment, the redundancy copter mechanisms could extract outwards extend and rotate upon one or more coaxial motors 130 in the center of the respective drone. In one embodiment, the drone 100 further comprises an electronic system 120 such as a global positioning system (GPS) to provide the location with accuracy by comparing coordinates, where the statistics could be used to calculate the direction of movement and speed of the drone 100. In one embodiment, the drone 100 further comprises one or more suspension spring-based landing mechanisms 122. The landing mechanisms 122 are integrated into the bottom side of the drone 100. In one embodiment, the landing mechanisms 122 could extend downwards during landing to facilitate a more proficient landing process.

In one embodiment, the external structure 102 comprises one or more propellers or fixed wings 128 securely and rotatably mounted on the motor 130. The drone 100 comprises the horizontal fixed wing construction 128, thereby enabling a most proficient airfoil to oppose its rotary constructions. In one embodiment, the external structure 102 is connected to the rotating mechanism 118 via the connecting rod 104. The drone 100 further comprises one or more vertical turbine assembly 132, where each turbine assembly comprises a turbine 134 and a pair of turbine blades 136. In one embodiment, the turbine 134 could be a rotary turbine. In one embodiment, the turbine blades 136 are fixed wings. In one embodiment, the turbine assembly 132 is a fixed wing and the rotary turbine construction. Further, the capacity of the fixed wings 136 and the rotary turbine 134 to rotate around the outer cyclical hull 110 enables the motorized drone 100 to rotate instantaneously in any direction. In one embodiment, the drone 100 further comprises one or more cameras mounted to the outer mechanism of the drone 100. The camera could rotate around the outer cyclical hull 110 using a motorized construction, for capturing a surrounding view of the drone 100.

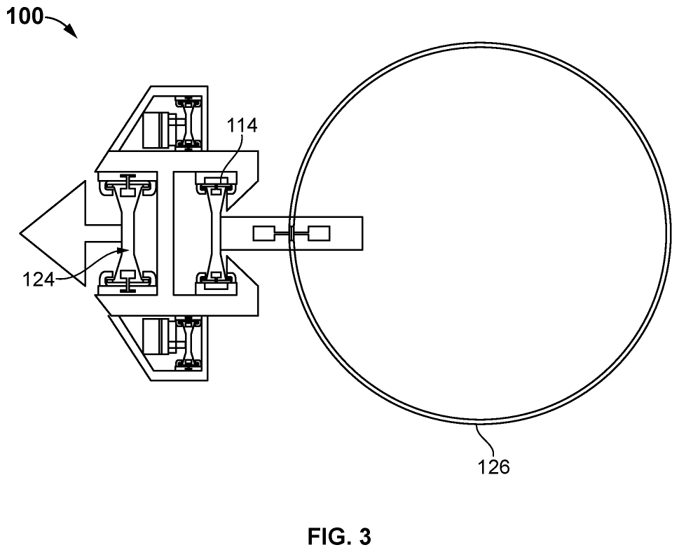

Referring to FIG. 3, the cyclical nature of the vertical turbine assembly 132 is disclosed, wherein the turbine assembly 132 rotates around the outer cyclical hull of the drone 100. In one embodiment, the turbine assembly 132 could be utilized as an energy harvesting mechanism. The cyclical rotational turbine assembly 132 is held in place or locked with the connection methodologies. In one embodiment, the cyclical rotational turbine assembly 132 is held in place with Bluetooth connection methodology such as Bluetooth locking mechanism 114. The Bluetooth locking mechanism 114 receives the alert or message from the plurality of sensors of the piezoelectric system 108, which is mounted on the outer cyclical hull 110 and unlocks the cyclical rotational turbine assembly 132. The unlocked cyclical rotational turbine assembly 132 could capture the excessive flight destabilizing wing. In one embodiment, the turbine assembly 132 could absorb a large portion of the wind force and the respective harvested energy. The absorption capability of the turbine assembly 132 enables the gyroscopic balancing of the drone 100 by reducing the oncoming wind force. Once the wind resistance and wind force are reduced, the turbine assembly 132 could lock itself to the Bluetooth locking mechanism 114 until the impression of extreme wind force on the turbine assembly 132. In one embodiment the Bluetooth locking mechanism 114 is an opposing Bluetooth locking mechanism. In one embodiment, the cyclical rotational turbine assembly 132 is constructed to have one or more motors. In one embodiment, one motor acts as an energy harvesting mechanism and the other motor acts as a rotational mechanism.

In one embodiment, the rotation of the external structure 102 around the outer cyclical hull 110 could be done via the rotational mechanisms 118, electromagnetic movement or magnetic movements. In one embodiment, the electricity passing through a medium in the electromagnetic movement could exponentially amplify the rotational movements. In one embodiment, the angular momentum mechanism 116 on an external ring or an outer ring construct 126 could be moved in a multiplicity of capabilities via the electromagnetic movement or the motorized rotational constructions 102. In one embodiment, the electrical components of the drone 100 interface with one another based on the signal received from the piezoelectric system 108 mounted in the outer cyclical hull 110 for efficiently analyzing the onward wind direction, thereby effectively rotating the external structure 102 at high speeds. The high-speed rotation of external structure 102 in the outer cyclical ring 126 enables the structural integrity of the drone. Further, the outer ring 126 rotates exponentially around the outer cyclical hull 110 and enables the angular momentum mechanism 116, which enables the gyroscopic stabilizing effect. Further, the gyroscopic stabilization effect enables the structural integrity of the construct to remain intact while in flight.

In one embodiment, the angular momentum mechanism 116 is moved under the constraints of the rotational mechanism 118, wherein the proficiency of the angular momentum mechanism 116 is imbued with the opposing magnetic field 124. The opposing magnetic field 124 is cylindrical. The opposing magnetic field 124 could function to levitate and effectively float the outer cyclical angular momentum mechanism 116, which subsequently enables the slightest indentation of force to induce the rotation of the outer ring 126. This capacity creates an autonomous angular momentum construction upon the impression of wind force. The impression of wind force is reduced due to the force dispersion, which is required for the circular rotation of the outer ring 126. Further, the unexpected gust wind in any other circumstance could derail the drone 100 from its natural trajectory, which could enable the rotation of outer cyclical construction or external structure 102 to absorb the force effect of the oncoming wind. The absorption of oncoming wind force reduces the wind force and enables the drone 100 to regain its trajectory and direction with more efficiency. In one embodiment, the movement of the outer ring 126 could be exponentially increased by the impression of electromagnetic forces on the outer ring 126. In another embodiment, the opposing magnetic field 124 acts as the levitating mechanisms to reduce the degrees of friction, wear and tear of the motorized gear constructions. Further, the magnetic ring construction having the same dimension of the motorized gear construction could be utilized as a medium to reduce the wear and tear of the gear construction. Also, it enables a frictionless movement around the cyclical mechanism.

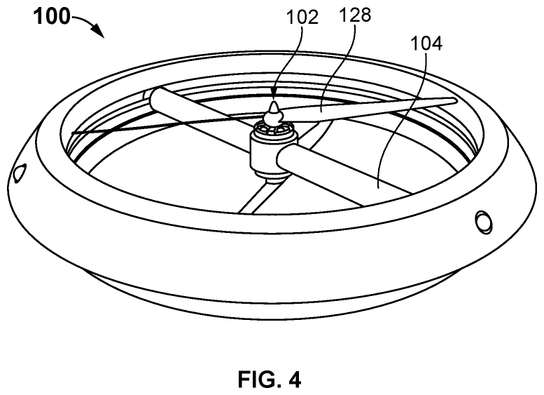

Referring to FIG. 4, a perspective view of the drone 100 is disclosed. In one embodiment, the internal spar or external structure 102 is configured to rotate the one or more propellers or fixed wings 128 in both clockwise direction and anti-clockwise direction, thereby enabling 360 degrees rotation and also enable easy maneuver of the drone 100.

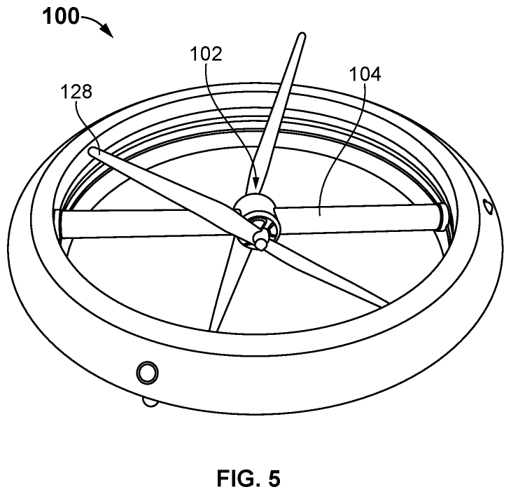

Referring to FIG. 5, a perspective view of the contra rotating blades or propellers or fixed wings 128 of the drone 100 at one position is disclosed. In one embodiment, the internal spar or external structure 102 is configured to enable forward and backward movement of the drone 100 based upon alternations of cyclical rotation of contra rotating blades or propellers or fixed wings 128. Alterations of cyclical movement enable effective decelerations converse acceleration in the opposing direction.

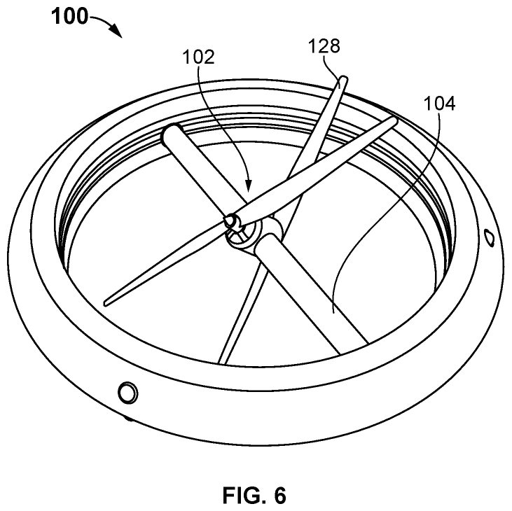

Referring to FIG. 6, a perspective view of the contra rotating blades or propellers or fixed wings 128 of the drone 100 at another position is disclosed. In one embodiment, the internal spar or external structure 102 is configured to enable immediate accelerated forward movement or flight of the drone 100 based upon alternations of cyclical rotation of contra rotating blades or propellers fixed wings 128.

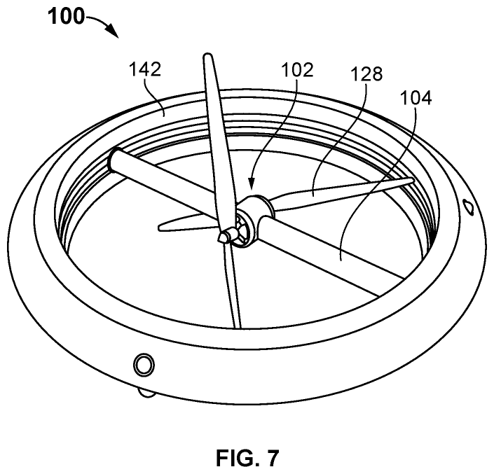

Referring to FIG. 7, a perspective view of the contra rotating blades or propellers or fixed wings 128 of the drone 100 at yet another position is disclosed. Upon the spar or external structure 102 being statically locked in place the contra rotating mechanisms, through variations of direction in RPM. The structure could rotate its body so as to define the direction upon which it chooses to accelerate.

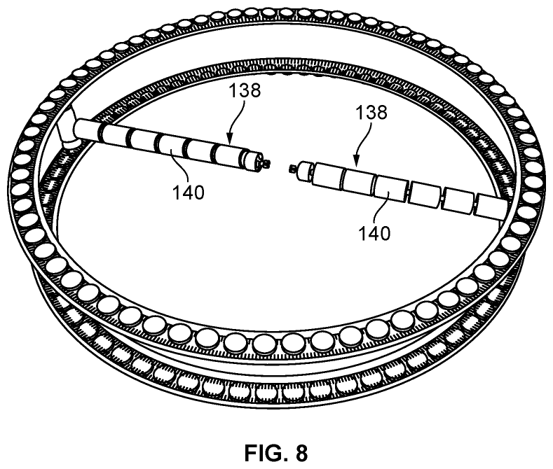

Referring to FIG. 8, a perspective view of a power storage unit 138 of the drone 100 in one embodiment is disclosed. In one embodiment, the power storage unit 138 further comprises one or more batteries 140. In one embodiment, the batteries 140 are configured to supply electrical power for efficiently operating the drone 100.

In one embodiment, there is an extension in the gyroscopic rings to aircraft and hovercraft as well as a drone, thereby ensuring that the same principle is in place for the magnetic levitation (maglev) like construct. In one embodiment, the rotational mechanism 118 around the cyclical rings that are harboured within a magnetically construct for enabling effective stability. In one embodiment, an aeroplane or a drone could maneuver around a cyclical ring that is held in a magnetic vice. The angular momentum mechanism 116 has validity both as a medium of aerodynamic stabilization through angular momentum by forcing the angular momentum mechanism 116 to spin whilst faced with extreme torrential wind, this enables the device to instantaneously stabilize due to the gyroscopic affect. The second element will be specific to the aircraft and unmanned aerial vehicle (UAV) as the aircraft/UAV propels and launches forward. The angular momentum mechanism 116 will automatically rotate continuously which will cause a perpetual stabilization in-flight.

In one embodiment, there is an extension in the magnetic opposite enclave or opposing magnetic field 124 for the aircraft and hovercraft as well as the drone 100. In one embodiment, there is an extension in the angular momentum mechanism 116 for the aircraft as well as the drone 100. In one embodiment, the locking systems 112 include locking and unlocking mechanisms are specific to the spa within the cyclical rings 110 and the same is applied to the aircraft and the hovercraft.

In one embodiment, the energy harvesting mechanism 106 or wind energy harvesting mechanism could act also as a stabilization mechanism by absorbing torrential wind conditions and reducing the effect of flight dislocation and managing the structural integrity of the construct.

The emphasis of the rotational mechanism 118 that manoeuvers around the cyclical ring, which is held in a magnetic enclave. This is a significant element specific to manage frictional wear and tear, as well as to prevent the dislocation of the drone 100 with the outer ring structure. In one embodiment, the magnetic mechanism holds the drone 100 in the levitated flux, which is significant in the context due to extreme wind impression so that the drone 100 could manoeuvre without breaking.

In one embodiment, the angular momentum mechanism 116 held in a magnetic enclave, could be the impression with electricity to enable rotation and angular momentum based stabilization. In another embodiment, the automated rotation of the angular momentum mechanism 116 causes automated angular stabilization.

In one embodiment, extension mechanisms are used in redundancy measures are telescopic. The telescopic effect enables effective lift within the flight. In one embodiment, the camera is also held in a magnetic flux, which is crucial in the sense that the frictional impact is mitigated the magnetic repulsing effect. That enables the camera to rotate around the ring.

In one embodiment, the angular momentum mechanism 116 could enable instantaneous stabilization under extreme weather conditions. Subsequently, less strain is placed upon the contra rotating propeller mechanism as a medium of stabilization. The angular momentum mechanism 116 is held in magnetic flux that may consequently enable rotation upon forward movement, perpetual angular momentum effect. This will enable autonomous angular momentum mechanism-based stabilization, similar in principle to the rotodyne aircraft.

In some embodiments, a machine learning element may be introduced in order to ascertain which medium of stabilization is the most proficient, whether it is the angular momentum construction or mechanism 116 or the utilization of contra rotating propellers 128. The contracting propellers 128 may not be of significant value under extreme weather conditions.

In one embodiment, the drone 100 further comprises an inner cyclical ring 142 that provides stabilization and dispersion of weight and force. In one embodiment, the inner ring 142 comprises at least four extruding spoke like constructions, which are in imbued with the respective motorized constructions. That rotates around the cyclical hulls of the drone 100. In one embodiment, the inner cyclical ring 142 comprises motorized protrusions that offers aerodynamic stabilization to the outer cyclical hull or ring 110.

In some embodiments, the drone 100 further comprises a rotational mechanism having magnetic levitation rings or magnetic rings, disposed on either side of the extruding rotational motor for enabling ring structure to be held in a magnetically levitated vice, which utilizes the opposing magnetic force to levitate the ring structure in place. The rotational mechanism around the cyclical rings that are harboured within a magnetical construct to enable effective stability.

In some embodiments, the drone 100 further comprises a multiplicity of Quoit rings for enabling the lever effect and increasing the distance of movement the force effect inherently multiplied, and subsequently, the strain is reduced upon the motorized constructions on either side of the contra rotating propellers 128.

In one embodiment, the drone 100 has the capacity to adapt and be efficiently utilized in any given terrain. The drone 100 is configured to enable instantaneous rotation, instant acceleration, (assessed based upon wind direction and airfoil utilization) instantaneous stabilization in extreme weather conditions (an assessment of efficiency of the angular momentum construction vs accelerometric stabilization).

In some embodiments, the drone 100 further comprises a flight control system integrated with machine learning (ML) for enabling the most optimized form of flight, optimizing the capability of the respective functional embodiments, and also enabling the most efficient stabilization data capture and acceleration in difficult terrain. The decision to utilize a specific functional embodiment, for instance, requires assessment and adjudication of a multitude of variable input factors. For example, data decision systems needed to assess whether to utilize accelerometer technology to effectively stabilize the drone 100 or the angular momentum mechanism 116. This decision will be determined by various input wind speed (piezoelectric sensors) different terrain (heat sensors), etc. and the efficiency of the decision-making process will determine both flight control and effective battery utilization. The machine learning system will exponentially enhance its flight decision-making, aerodynamic proficiency, and its functional optimization.

In some embodiments, the drone 100 could fly on an entirely novel and proprietary disparate software system. The contrarotating propellers 128 are used as a statically fixed beam for rotating the entire structure of the drone structure in the required direction to propel forward. This capability enables the use of wind flow and rotational RPM in opposing directions to manoeuvre the entire body of the drone 100.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A drone aircraft with magnetic construct, comprises:
a cyclical hull with one or more outer cyclic rings;
one or more external structures securely and rotationally connected to the one or more cyclical ring by connecting to a rotational mechanism via a rotatable connecting rod, thereby enabling the external structure to rotate in both clockwise direction and anti-clockwise direction to enable easy maneuver of the drone,
wherein the one or more external structure comprising one or more propellers and a cyclical rotational turbine assembly;
wherein the one or more propellers are securely and rotatably mounted on a motor assembly to enable most proficient airfoil to oppose its rotary constructions;
a piezoelectric system securely mounted on the cyclical hull, wherein the piezoelectric system comprising a plurality of sensors to measure the changes in parameters for efficiently analyzing onward wind direction, thereby effectively rotating the external structure at high speeds to enable structural integrity of the drone;
an energy harvesting mechanism configured to convert ambient energy such as light, wind, vibration, sound, and heat directly into electrical energy for the operation of the drone, and
an angular momentum mechanism, configured to enable the gyroscopic stabilizing effect for the drone, wherein the angular momentum mechanism is imbued with opposing magnetic-based constructions, wherein the opposing magnetic-based constructions function to levitate and effectively float the angular momentum mechanism, which subsequently enables the slightest indentation of force to induce the rotation of an outer ring of the drone.

2. The drone aircraft of claim 1, wherein the external structure is configured to rotate exponentially around the cyclical hull, thereby enabling a stabilization capability of the drone to forward in the desired direction.

3. The drone aircraft of claim 1, wherein the one or more propellers having a horizontal fixed wing construction.

4. The drone aircraft of claim 1, wherein the plurality of sensors of the piezoelectric system is configured to measure the changes in parameters include acceleration, strain, wind force, and other weather conditions.

5. The drone aircraft of claim 1, further comprises one or more locking mechanisms, wherein the locking mechanisms are configured to lock and unlock the energy harvesting mechanism and turbine assembly by receiving alerts and/or signals from the plurality of sensors of the piezoelectric system.

6. The drone aircraft of claim 5, wherein the locking mechanism is a magnetic locking system.

7. The drone aircraft of claim 5, wherein the locking mechanism is a Bluetooth locking mechanism.

8. The drone aircraft of claim 1, further comprises a power storage unit having one or more batteries, wherein the batteries are configured to supply electrical power for operating the drone aircraft.

9. The drone aircraft of claim 1, wherein the turbine assembly is configured to rotate around the outer cyclical hull for enabling the drone to rotate instantaneously in any direction.

10. The drone aircraft of claim 1, wherein the cyclical rotational turbine assembly is a vertical axis motorized cyclical wind turbine and a cylindrical wind turbine assembly.

11. The drone aircraft of claim 1, wherein the cyclical rotational turbine assembly absorbs a large portion of an excessive flight destabilizing wind and a respective harvested energy, thereby enabling the gyroscopic balancing of the drone by reducing the oncoming wind force.

12. The drone aircraft of claim 1, wherein the opposing magnetic-based constructions is configured to enable the drone to effectively float until the respective direction is determined and subsequently locked in place upon forward movement.

13. The drone aircraft of claim 1, wherein the opposing magnetic-based constructions act as a levitating mechanism to reduce the degrees of friction, wear and tear of the motorized gear constructions.

14. The drone aircraft of claim 1, wherein the opposing magnetic-based constructions includes one or more magnetic levitation rings.

15. The drone aircraft of claim 1, wherein the outer cyclical ring is configured to rotate exponentially around the cyclical hull and enable the angular momentum mechanism

16. The drone aircraft of claim 1, further comprises an electronic system such as a global positioning system (GPS) to provide the location with accuracy by comparing coordinates, where the statistics could be used to calculate the direction of movement and speed of the drone.

17. The drone aircraft of claim 1, further comprises one or more suspension spring-based landing mechanisms to facilitate a more proficient landing process.

18. The drone aircraft of claim 1, further comprises at least one camera, securely positioned at the external structure, wherein the camera is configured to rotate around the cyclical hull to capture a surrounding view of the drone.
